(19) United States
(12) Patent Application Publication
(10) Pub. No.: US 2006/0226723 A1
(43) Pub. Date: Oct. 12, 2006

(54) Magnet power

(76) Inventors: Carlos T. Paredes, Miami, FL (US); Kharlos M. Paredes, Miami, FL (US)

Correspondence Address: Carlos T. Paredes, 467 SW 90 Ct., Miami, FL, 33174, US

(21) Appl. No.: 10/974,572

(22) Filed: Apr. 5, 2005

(51) Int. Cl. H02K 21/00

(52) U.S. Cl. 310/152

(57) ABSTRACT

This invention creates electrical energy using the forces of powerful magnets attached to a rotary. The rotary is inserted through a box-like structure which is filled with magnets. The magnets on the rotary are placed in the opposite direction to those in the box to create the resistance created when magnets of the same polarity are faced each other. The force created by the resistance makes the rotary spin extremely fast within the box. The rotary is connected to a belt and then attached to an electric generator. The spinning motion of the rotary puts the generator in motion which then creates the energy it was designed to create, without the use of fuel, wind, or radioactive material.

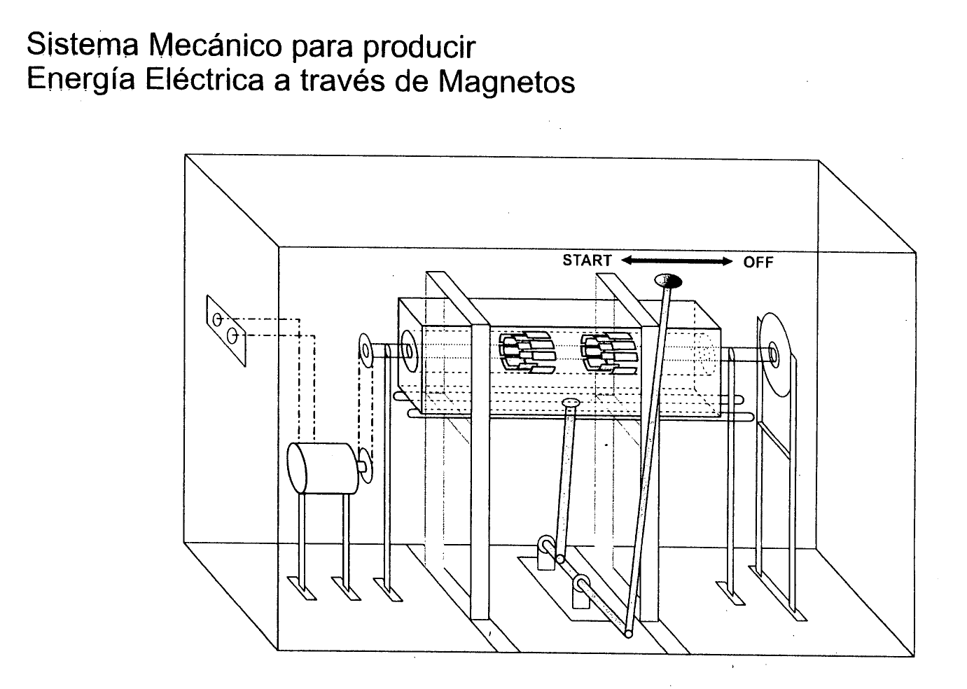

The graphical present shows pieces of powerful magnets placed some on an axle, and others, in the interior part of a box that covers it, which uses as coverlet to the axle. The magnets are placed in opposite direction causing them to repel themselves, imposing a rotary constant movement to the axle. This rotary movement of the axle, we propose to produce from 0.5 up to 8.00 kilos/watts of electricity, without using the conventional energies: Atomic, lot, derivatives of oil, mineral coal, vegetable coal, water, air, etc.

With the develop of the present MODEL OF USEFULNESS, we initiate an experimental project of electrical production, in minimal quantities initially.

The dimensions of the parts used in this MODEL OF USEFULNESS, they are measured Brought near, given the probabilities of modification of the same ones, as soon as we are developing the project.

The approximate measurements used in the present design are the following ones:

Edge in the shape of bars, with measurements of 15.00 centimeters of length, 5.00 centimeters of width, by 3.00 centimeters of thickness.

A uniform axle, of material insulating and resistant to the high temperatures, with 90.00 centimeters of length and 8.00 centimeters of diameter, is placed on two or more points of support, which point turns on a box of bearing. In the axle two or more rows of magnets are placed forming a ring every row and his forces of push directed towards out. In one of the ends of the axle, there is installed a wheel in which a belt is connected to move a generator.

### GENERATOR

A Conventional Generator.

The box composed by two pieces of material also insulating and resistant to the high temperatures, has rectangular form and measurements of 80.00 centimeters of length; 18.00 centimeters in his interior width; 21.00 centimeters in his exterior width, and Equal measurements in his interior and exterior height. In his interior it has the same quantity of magnets that installed in the axle.

We claim our invention to be the production of energy using the power of magnets which:

1. Create motion to a rotary that then can be connected via a turning belt to a generator or any other such equipment that require motion to get them working. This motion is usually produced by a fuel powered motor engine, in our invention it is produced by magnets.
